(19) United States
(12) Patent Application Publication
(10) Pub. No.: US 2019/0362510 A1
(43) Pub. Date: Nov. 28, 2019

(54) METHOD AND SYSTEM FOR EVALUATING FRICTION COEFFICIENT AND SKID RESISTENCE OF A SURFACE

(71) Applicants: Lu Sun, Rockville, MD (US); Yuanyuan Wang, Chongqing (CN)

(72) Inventors: Lu Sun, Rockville, MD (US); Yuanyuan Wang, Chongqing (CN)

(21) Appl. No.: 15/988,312

(22) Filed: May 24, 2018

(51) Int. Cl. G06T 7/49; G01N 19/02

(52) U.S. Cl. CPC G06T 7/49; G01N 19/02

(57) ABSTRACT

The invention is one method for evaluating sliding resistance of surface. The evaluation standard from different test methods is not unified, which brings a lot of inconvenience to the detection and evaluation of pavement sliding resistance. The invention is conducted to improve the traditional friction coefficient-based evaluation method and expand the applicable scope. The invention provides a method to acquire both macro and micro texture morphology of pavement at the same time, which can be used to measure characteristics of a surface topology. Based on the 3D texture morphology, texture morphology-based characterization indicators about the aspects of height, wavelength and shape are established, respectively. The invention also provides one relational model for expressing the relationship between friction coefficients and texture indicators. Additionally, the invention introduces IFI (international friction index) to build the evaluation system of pavement sliding resistance completely based on the 3D texture. The proposed evaluation system based on texture overcomes the disadvantages that the restrictions of friction coefficient-based evaluation method are strong. The proposed evaluation system is simple to operate and implement. It can directly finish the evaluation of pavement sliding resistance only needing to acquire pavement texture. It also combines with the advantages of IFI evaluation system, which is conducive to harmonize and unify different detection equipments of pavement sliding resistance.

### CROSS-REFERENCE TO RELATED APPLICATIONS

Saito, et al. (1996) show the fixed site equipments (such as: CTMeter (Circular Track Texture Meter), British Pendulum Tester, Dynamic Friction Tester, etc.) need to temporarily interrupt the traffic and affect the normal traffic flow. Choubane and Charles (2004) used continuous measurement equipments to test pavement sliding resistance. And the severe shortcoming of continuous measurement equipments is their expensive price. During the process of analyzing pavement sliding resistance, Kowalski (2008) and Doty (1975) gave the evaluation indicators that mainly focused on height-correlated indicators such as Mean Texture Depth (MTD) and Root Mean Square Roughness (RMSR) measured by circular track texture meter or sand patch method. These indicators are just the height-correlated and cannot reflect well on the longitudinal or transverse features and distribution characteristics of overall surface texture morphology. Additionally, these indicators acquired by current test equipment (circular track texture meter, sand patch method, etc.) cannot well describe pavement surface macro texture morphology due to the lack of test precision.

### FIELD OF THE INVENTION

The present invention relates to one method and system for evaluating friction coefficient and sliding resistance of a surface. More specifically, the present invention belongs to civil, and transportation, which relates to a evaluation system of sliding resistance that may be used to directly finish the evaluation of pavement sliding resistance only needing to acquire pavement texture. This evaluation system but also combines with the advantages of IFI evaluation system, which is conducive to harmonize and unify different detection equipments of pavement sliding resistance.

### BACKGROUND OF THE INVENTION

Due to worse coordination between people, vehicle and road, traffic safety problem has become one of the serious problems. Inadequate anti-sliding ability of pavement is a substantial reason for the traffic accidents. The personal casualties and economic loss that caused by traffic accidents due to insufficient anti-sliding performance is shocking. Statistical results from world health organization (W. H. O.) showed that global traffic accidents caused 1.2 million deaths and 50 million injuries per year on average and the economic losses in every year was about $518 billion. For the frequent occurrence of traffic accidents, the insufficient anti-sliding ability of road surface is one main reason. Accordingly, a satisfactory anti-sliding performance is the guarantee for traffic safety.

However, the traditional friction coefficient-based evaluation method used for evaluating the sliding resistance of pavement is limited by two reasons. Firstly, different test equipment of friction coefficient has some inherent limitations. For example: The fixed site equipment (e.g., British Pendulum Tester, Circular Track Texture Meter, Dynamic Friction Tester) needs to temporarily interrupt the traffic and affect the normal traffic flow. And the severe shortcoming of continuous measurement equipments is their expensive price and they are different to implement the measurement indoor. Secondly, the conditioned restrictions of measurement of friction coefficient are strong. The friction coefficient will be changed with the variation of test speed and the dry or waterish state of pavement.

Fortunately, a large number of studies have shown that the sliding resistance of pavement is closely related to the characteristics of texture morphology. The 18th session of the World Conference on road surface characteristics gave a definition to texture morphology of pavement. Pavement surface texture morphology is defined as spatial deviation of surface elevation from a flat plane. The texture morphology was separated into macro texture morphology and micro texture morphology. The macro texture morphology is mainly determined by the size, shape, arrangement of aggregates and so on, whose depth is from 0.2 mm to 10 mm and the width is from 0.5 mm to 50 mm. But for the micro texture morphology, whose depth and width are respectively less than 0.2 mm and 0.5 mm. It is the main reason that influences the sliding resistance under the condition of low speed driving. Both macro and micro texture morphology have a decisive influence on the anti-sliding performance. Therefore, evaluation method based on pavement surface texture morphology was taken into account, which was firstly needed to acquire the texture morphology of asphalt pavement and build the characterization indicators based on texture morphology.

Nevertheless, during the process of analyzing pavement sliding resistance, the evaluation indicators applied in actual are mainly focused on height-correlated indicators such as Mean Texture Depth (MTD) and Root Mean Square Roughness (RMSR) measured by circular track texture meter or sand patch method. These indicators are just the height-correlated and cannot reflect well on the longitudinal or transverse features and distribution characteristics of overall surface texture morphology. Additionally, these indicators acquired by current test equipment (circular track texture meter, sand patch method, etc.) cannot well describe pavement surface macro texture morphology due to the lack of test precision. As a result, which lead to traditional texture morphology indicators cannot fully express the abundant information of pavement surface texture morphology.

No matter the completion acceptance or maintenance decision, pavement sliding resistance as one key indicator affects many questions (e.g., the quality inspection of road, pavement performance evaluation, the choice of maintenance time and plan, etc.). Therefore, establishing reasonable evaluation method of sliding resistance is necessary to guarantee project quality and help project managers make decisions. However, different countries in the world have established their own standards using to evaluate the pavement sliding resistance. For different countries, the evaluation standards are also different. The disunity of evaluation standards not only can bring inconvenience to the detection and evaluation of pavement sliding resistance, but also can give an obstacle to the communication of researchers coming from different countries.

In order to replace the traditional friction coefficient evaluation parameters and establish the texture morphology-based characterization indicators, the 3D (three-dimension) pavement surface texture morphology containing both macro and micro texture morphology was firstly acquired by improved photometric stereo reconstruction method in the invention. Then the texture morphology-based characterization indicators were established. Pavement surface 3D (three-dimensional) texture-based evaluation system is finally taken into account in this invention, which has paramount significance for simplifying, unifying and popularizing the evaluation of pavement sliding resistance.

### SUMMARY OF THE INVENTION

Generally, the present invention is mainly focused on height-correlated indicators. These indicators cannot reflect well on the longitudinal or transverse features and distribution characteristics of overall surface texture morphology. Additionally, these indicators acquired by current test equipment cannot well describe pavement surface macro texture morphology due to the lack of test precision. As a result, the traditional texture morphology indicators cannot fully express the abundant information of pavement surface texture morphology.

This invention presents one method for evaluating sliding resistance of surface. It is conducted to improve the traditional friction coefficient-based evaluation method and expand the applicable scope. The proposed evaluation system based on texture overcomes the disadvantages that the restrictions of friction coefficient-based evaluation method are strong. The proposed evaluation system is simple to operate and implement. It can directly finish the evaluation of pavement sliding resistance only needing to acquire pavement texture.

The operation of three-dimension (3D) topology detection apparatus is composed by two steps including the solving of normal vector and the normal vector-based 3D reconstruction. The previous step is achieved by low-rank approximation algorithm from six images. And the latter step is finished by global integration reconstruction algorithm based on the principle of variation. 3D topology detection apparatus test system, FIG. 1, used six light sources from different incident direction to illuminate the pavement. The system mainly includes the camera, the light source, the power controller and the equipment bracket. The advantages of the 3D topology detection apparatus are mainly embodied as follows: first, six light sources are used to eliminate incomplete information retrieval and enhance the illumination intensity; second, the traditional median filtering method is removed because it loses more details of images and cannot process the problems caused by highlights and shadow; finally, the introduction of the low-rank approximation can better process the problems caused by noise, highlights and shadow. The specific flow chart of the establishment of proposed evaluation system is shown in FIG. 2.

3D texture-based characterization indicators about the aspects of height, wavelength and shape were established. Additionally, the correlation between texture-based indicators and pavement sliding resistance was also analyzed. The results show that MTD, S, λ, and Sₖ have a significant correlation relationship with pavement sliding resistance. Therefore, MTD (mean texture depth), S (average spacing of single-peak), λ (root mean square wavelength) and Sₖ (skewness) regarded as texture-based characterization indicators are selected to describe pavement rough characteristics, Equations (1)-(4). In order to distinguish macro- and micro-texture-based characterization indicators, the sign, 1, was added behind the corresponding indicators to denote micro-texture indicators. For example: the signs MTD and MTD1 are defined as the Mean Texture Depth based on macro- and micro-texture, respectively.

$$\begin{matrix}MTD ( MTD 1 ) = \frac{1}{M \times N} {\sum }_{i = 1}^{N} {\sum }_{j = 1}^{M} [ {z}_{p} ( {x}_{i} , {y}_{j} ) - z ( {x}_{i} , {y}_{j} ) ] & ( 1 ) \\ S ( S 1 ) = \frac{1}{p} {\sum }_{i = 1}^{p} {S}_{i} & ( 2 ) \\ λ ( λ 1 ) = 2 π \frac{\sqrt{\frac{1}{M \times N} {\sum }_{i = 1}^{N} {\sum }_{j = 1}^{M} {( z ( {x}_{i} , {y}_{j} ) )}^{2}}}{\begin{matrix}\sqrt{\frac{1}{( M - 1 ) \times ( N - 1 )}} {\sum }_{i = 1}^{N - 1} {\sum }_{j = 1}^{M - 1} ( ( \frac{z ( {x}_{i + 1} , {y}_{j} ) - z ( {x}_{i} , {y}_{j} )}{Δ x} ) + \\ {( \frac{z ( {x}_{i} , {y}_{j + 1} ) - z ( {x}_{i} , {y}_{i} )}{Δ y} ) )}^{2}\end{matrix}} & ( 3 ) \\ {S}_{k} ( {S}_{k} 1 ) = \frac{1}{{( \frac{1}{M \times N} {\sum }_{i = 1}^{N} {\sum }_{j = 1}^{M} {( z ( {x}_{i} , {y}_{j} ) )}^{2} )}^{\frac{3}{2}}} \frac{1}{M \times N} {\sum }_{i = 1}^{N} {\sum }_{j = 1}^{M} {z}^{3} ( {x}_{i} , {y}_{j} ) & ( 4 )\end{matrix}$$

Where M and N are respectively the numbers of sampling points on the direction of width and length; z(xᵢ,yⱼ) is the offset of texture morphology on the coordinates (xᵢ,yⱼ); zₚ(xᵢ,yⱼ) is the line of profile peaks that is parallel to the baseline and through the highest point of morphology; p is the number of spacing of single-peak; Sᵢ is i^{th} spacing of adjacent single-peak; Δx and Δy are respectively sampling interval along X and Y direction.

British pendulum tester, FIG. 3, and dynamic friction tester, FIG. 4, which are feasible, easy to operate and also can realize indoor measuring, will be chosen to analyze and characterize the anti-sliding performance of asphalt pavement. The measurement results, British Pendulum Number (BPN), of British pendulum tester can be used to evaluate the anti-sliding performance under the condition of low speed driving. While dynamic friction tester can simulate driving speed of 0-80 km/h, the results, Dynamic Friction Coefficient at speed of 60 km/h (DF₆₀) can be used to evaluate the anti-sliding performance at high driving speed.

In the evaluation system of claim 1, the establishment of relational model should integrate different 3D texture indicators into a synthetic vector: M=[MTD, MTD1, S, S1, Sₖ, Sₖ1, λ, λ1]. For the regression model of BPN, four indicators (X, MTD1, Sk1 and λ) are finally retained to constitute synthetic vector: M₁=[X, MTD1, Sₖ1, λ_{q}]. But for DF₆₀, five indicators (X, Y, MTD, Sₖ1 and λ) are finally retained to constitute synthetic vector M2. Then the multiple quadratic polynomial models between DF₆₀ and M2 is constructed.

The establishment of the evaluation system takes into account the rough characteristics of 3D texture morphology. The procedure is as following:

1) Calculate the speed number Sₚ. Sₚ is a function of pavement macro-texture structure. The calculation of Sₚ can be expressed by the following:

Sₚ=a+b Tₓ (5)

where, Tₓ is the pavement macro-texture morphology indicators (e.g., MTD, MPD (Mean Profile Depth),etc.); a and b are regression coefficients, also known as the calibration parameters of pavement macro-texture structure.
2) The measured friction coefficient at testing speed of S is translated into the correction friction coefficient, Equation (6).

FR60=FRS·exp[(S−60)/Sₚ] (6)

3) Based on FR60, the friction under standard testing speed, F60, is calculated. For different testing tire tread, the calculation of F60 satisfies the following:

Smooth tires: F60=A+B FR60

Pattern tires: F60=A+B FR60+C Tₓ (7)

where, A, B and C are calibration parameters of testing equipments used to measure pavement friction coefficient. The calibration parameters of pavement macro-texture structure (a and b) and the calibration parameters of testing equipments (A, B and C) are all listed in PIARC report. Sₚ and F60 can be easily obtained only by referring to the corresponding data table.
4) Calculate IFI. IFI was defined as the function containing two parameters (Sₚ and F60): IFI(F60, Sₚ). In IFI evaluation system, the friction coefficient at any testing speed can be calculated:

F(S)=F60·exp[(S−60)/Sₚ)] (8)

5) According to the characterization indicators acquired by 3D topology detection apparatus and the relational model, solve Sₚ and F60 in accordance with Step 1), 2), 3) and 4), and finish the establishment of the evaluation system.

the 3D texture-based evaluation system of pavement sliding resistance is presented. This proposed evaluation system not only combines with the advantages of IFI evaluation system, but also overcomes the disadvantages of the friction coefficient index-based evaluation system, which is help to harmonize different testing results from different detection equipments. Additionally, this improved evaluation system that is simple to operate and implement can directly finish the evaluation of pavement sliding resistance only needing to acquire pavement texture.

### BRIEF DESCRIPTION OF THE DRAWINGS

FIG. 1 is the schematic diagram of 3D topology detection apparatus;

FIG. 2. is the flow chart of the establishment of proposed evaluation system;

FIG. 3 is the schematic of British pendulum tester;

FIG. 4 is the schematic of Dynamic friction tester.

### DETAILED DESCRIPTION

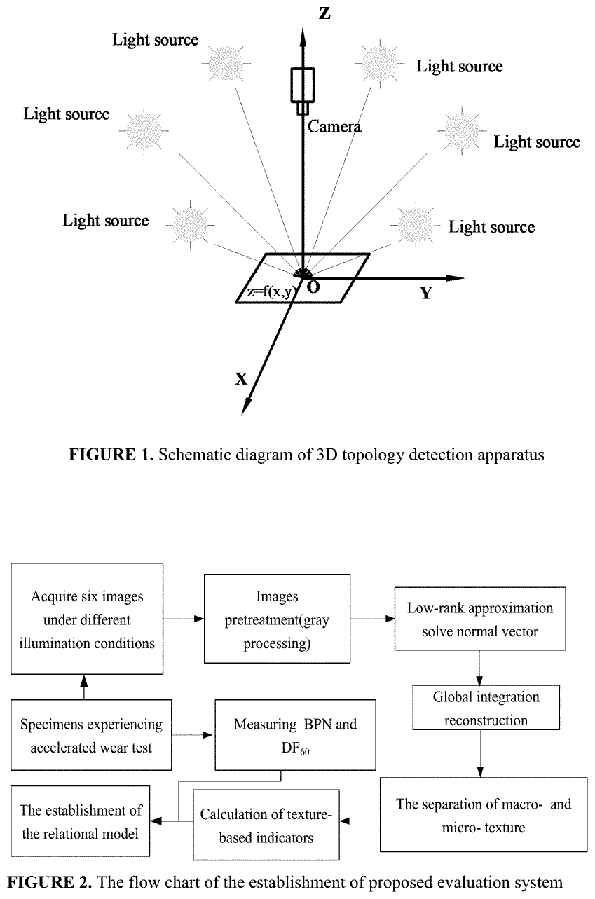

FIG. 1 is a schematic diagram of 3D topology detection apparatus. Six light sources and low-rank approximation algorithm are used to improve traditional three light sources-based photometric stereo. In the 3D topology detection apparatus system, six light sources are first used to instead of 3 light sources for enhancing the illumination and eliminate incomplete information retrieval; then low-rank approximation algorithm is adopted to solve the normal vector; finally, on the basis of normal vector, 3D texture morphology of asphalt mixture specimen was reconstructed by global integration method. The median filtering method in traditional photometric stereo is removed for keeping more local details of images. The 3D topology detection apparatus can efficiently, accurately and comprehensively measure both macro- and micro-texture morphology of pavement surface at the same time, which is dedicated to overcome the pavement special characteristics including highlights, shadows regions and discontinuous surface characteristics.

FIG. 2 is a depiction of the flow chart of the establishment of proposed evaluation system. The evaluation system should first acquire images under different illumination conditions for finishing the solving of 3D texture morphology of surface by 3D topology detection apparatus; Then, 3D texture-based characterization indicators about the aspects of height, wavelength and shape are established, respectively; Finally, the relational model and the evaluation system between performance and 3D texture-based characterization indicators is established through integrating different 3D texture indicators into a synthetic vector.

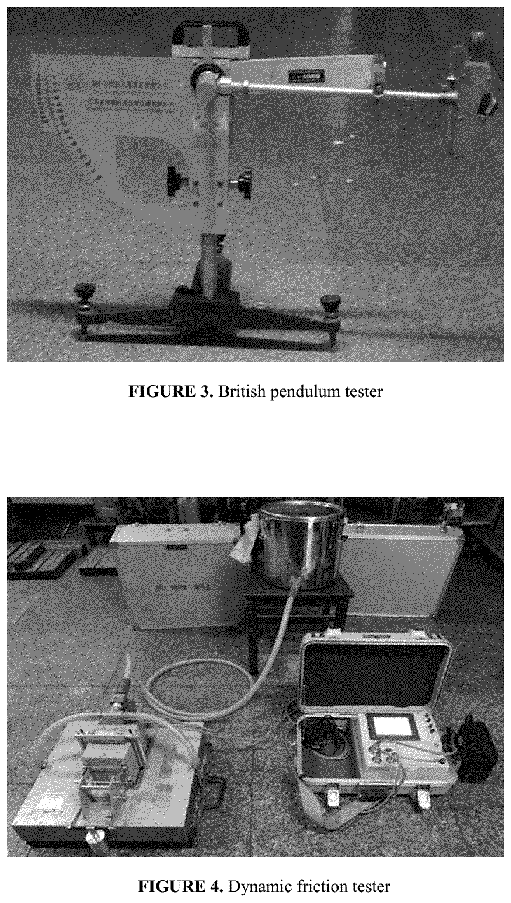

FIG. 3 is the schematic of British pendulum tester. The slip rubber on the surface of pendulum mass is contacted with the pavement surface when the pendulum mass of British pendulum tester free fall from a certain height. According to the principle of conservation of energy, the potential energy of swing arm will convert to the work done by frictional force. Then British Pendulum Number (BPN) regarding as one kind of friction coefficient evaluation index can be read on the pendulum instrument dial due to energy loss caused by friction effect. Because the slip velocity of pendulum mass in British pendulum tester is about 10 km/h, this method can better reflect the anti-sliding performance of pavement under low driving speed. However, the anti-sliding performance under low driving speed is mainly depended on the micro-texture morphology structure features of pavement surface. Therefore, the measurement results of British pendulum tester can characterize the pavement micro-texture morphology and be used to evaluate the pavement sliding resistance under low driving speed.

FIG. 4 is the schematic of Dynamic friction tester. It is mainly composed of turnplate that is parallel to the test surface and three rubber slippers fixed on turnplate. It can be used to measure the dynamic friction coefficient (DF) for evaluating pavement slide resistance. In the measurement mode, frictional force will be produced between the rubber slippers and the road surface when the turnplate is contact with pavement and begins to rotate. Dynamic friction tester can simulate driving speed of 0-80 km/h. Under the condition of high testing speed, it can well characterize the information of macro-texture morphology of pavement surface. Generally, the dynamic friction at the speed of 60 km/h, DF60, is adopted to evaluate the sliding resistance. In this invention, DF60 regarded as the friction coefficient indicator is used to establish the relationship model between sliding resistance and 3D texture indicators.

1. The evaluation system for evaluating sliding resistance of surface comprising: A three-dimension (3D) topology detection apparatus, the establishment of texture morphology-based characterization indicators and the establishment of relational model between surface sliding resistance and texture morphology-based characterization indicators.

2. The three-dimension (3D) topology detection apparatus in the evaluation system of claim 1 comprising: one camera, six light sources, one power controller and an equipment bracket.

3. The 3D topology detection apparatus of claim 2, wherein the slant angles of six light sources are all 45° and the tilt angle of six light sources is 0°, 60°, 120°, 180°, 240°, and 300°, respectively. Six photos under different illumination are taken by the camera. The texture morphology information is solved by computer programming like low-rank decomposition method and control point-based interpolation surface algorithm.

4. The 3D topology detection apparatus of claim 1 the method is improved based on the traditional photometric stereo algorithm to increase the test accuracy. The procedure to solve normal vector is as following:
1) Take six photos under different illumination;
2) Gray the photos;
3) Composite intensity matrix of six photos is processed by modified low-rank decomposition method to solve normal vector.
4) 3D texture morphology of the test area of pavement is solved by global integral reconstruction algorithms on the basis of step 3;
5) Coordinate information of control points is tested by three-dimensional coordinate instrument;
6) On the basis of step 4 and 5, solution accuracy of three-dimensional texture morphology is improved by adopting control point-based interpolation surface algorithm.

5. The evaluation system of claim 1, wherein the choice of characterization indicators not only asks for the significant correlation between performance and indicators, but also satisfies the requirements of dimension reduction that is used to avoid multicollinearity problem. Texture morphology-based characterization indicators about the aspects of height, wavelength and shape are established.

6. The evaluation system of claim 1, wherein British pendulum tester and dynamic friction tester, which are feasible, easy to operate and also can realize indoor measuring, are chosen to analyze and characterize the anti-sliding performance of asphalt pavement. The measurement results, British Pendulum Number (BPN), of British pendulum tester can be used to evaluate the anti-sliding performance under the condition of low speed driving. While dynamic friction tester can simulate driving speed of 0-80 km/h, the results, Dynamic Friction Coefficient at speed of 60 km/h (DF₆₀) can be used to evaluate the anti-sliding performance at high driving speed.

7. The evaluation system of claim 1, wherein the establishment of relational model should integrate different 3D texture indicators into a synthetic vector: M=[MTD, MTD1, S, S1, Sₖ, Sₖ1, λ, λ1]. For the regression model of BPN, four indicators (X, MTD1, Sₖ1 and X) are finally retained to constitute synthetic vector: M₁=[X,MTD1, Sₖ1, λ_{q}]. But for DF₆₀, five indicators (X, Y, MTD, Sₖ1 and λ) are finally retained to constitute synthetic vector M2. Then the multiple quadratic polynomial models between DF₆₀ and M2 is constructed.

8. The evaluation system of claim 1, wherein the establishment of the evaluation system takes into account the rough characteristics of 3D texture morphology. The procedure is as following:
1) Calculate the speed number Sₚ. Sₚ is a function of pavement macro-texture structure;
2) The measured friction coefficient at testing speed of S is translated into the correction friction coefficient;
3) Based on FR60, the friction under standard testing speed, F60, is calculated;
4) Calculate IFI. IFI was defined as the function containing two parameters (Sₚ and F60): IFI(F60, Sᵣ). In IFI evaluation system, the friction coefficient at any testing speed can be calculated;
5) According to the characterization indicators of claim 5 acquired by 3D topology detection apparatus of claim 2, the relational model of claim 7, solve Sₚ and F60 in accordance with Step 1), 2), 3) and 4), and finish the establishment of the evaluation system.
